(19) United States
(12) Patent Application Publication
(10) Pub. No.: US 2026/0365151 A1
(43) Pub. Date: Nov. 19, 2026

(54) OIL PIPE QUICK-CONNECT STRUCTURE AND A HYDRAULIC DISC BRAKE SYSTEM

(71) Applicant: LANXI JIEKE SPORTS APPARATUS MANUFACTURING CO., LTD., Jinhua (CN)

(72) Inventors: Zhijun YU, Jinhua (CN); Sibin WU, Jinhua (CN); Yao CHENG, Jinhua (CN)

(21) Appl. No.: 19/730,930

(22) Filed: Jul. 3, 2026

Related U.S. Application Data
(63) Continuation of application No. PCT/CN2025/074486, filed on Jan. 23, 2025.

(30) Foreign Application Priority Data
Nov. 22, 2024 (CN) 202411683988.6
Dec. 25, 2024 (CN) 202411928412.1

(51) Int. Cl. B60T 17/04; F16L 37/248

(52) U.S. Cl. CPC B60T 17/043; F16L 37/248

(57) ABSTRACT

The present disclosure relates to an oil pipe quick-connect structure and a hydraulic disc brake system. The oil pipe quick-connect structure comprises a first oil pipe, a connecting piece, and an adapter piece. The connecting piece and the adapter piece are engaged by a snap-fit to establish a continuous oil path. The connecting piece comprises a first plug-in portion and a snap portion arranged on a side wall of the first plug-in portion. The adapter piece comprises: a main body portion, which is hollow and axially provided with a first accommodating cavity, a second accommodating cavity, and a third accommodating cavity; a bayonet portion, which is opened on a side wall surface of the first accommodating cavity and communicates with the second accommodating cavity; and a locking piece, which is fixedly assembled on an outer wall of the main body portion.

### CROSS-REFERENCE TO RELATED APPLICATIONS

This application is a continuation of International Application No. PCT/CN2025/074486 with a filling date of Jan. 23, 2025, designating the United states, now pending, and further claims to the benefit of priority from Chinese Application No.202411683988.6 with a filing date of Nov. 22, 2024, and Chinese Patent Application No.202411928412.1 with a filing date of Dec. 25, 2024. The content of the aforementioned applications, including any intervening amendments thereto, are incorporated herein by reference.

### TECHNICAL FIELD

The present disclosure relates to the technical field of hydraulic disc brakes, specifically to an oil pipe quick-connect structure and a hydraulic disc brake system.

### BACKGROUND

A hydraulic bicycle brake system mainly comprises an upper brake pump on the bicycle, a lower brake pump mounted beside the wheel, and a hydraulic oil pipe connecting the upper brake pump and the lower brake pump, wherein the lower brake pump comprises a brake caliper that works in conjunction with a brake disc rotor on the front/rear wheel. When installing a brake system on an internally routed bicycle, the oil pipe connected to the upper brake pump and the lower brake pump needs to pass through the interior of the bicycle frame and connect to the upper brake pump and the lower brake pump at the other end.

Since the oil pipe is pre-filled with the brake fluid, the joints at both ends of the oil pipe are sealed. A common sealing method is surface sealing. After the oil pipe is threaded through the frame, installation of the oil pipe joint typically requires a wrench to tighten the joint screw, causing internal components to deform and form a seal. However, this method requires applying a set torque with a wrench, insufficient torque will result in the oil leakage risk, and the process is relatively time-consuming and labor-intensive.

With technological development, self-sealing methods have emerged. In these methods, the oil pipe joint seals the oil pipe port (i.e., the oil outlet of the joint) by elastic plugging in a non-connected state, and releases the elastic plugging in a connected state to open the oil path. However, using a self-sealing method significantly increases the volume and diameter of the oil pipe joint to ensure sufficient oil passage channel inside to maintain the oil flow required for braking. The diameter of the brake cable passage hole in mainstream bicycle frames is typically designed as a standard, i.e. 7 mm. When the joint's outer diameter approaches or exceeds 7 mm, threading the oil pipe internally through the frame faces significant frictional resistance and may even fail to pass through the hole. If the internal oil path is compromised to reduce the outer diameter, it can lead to insufficient brake fluid flow, affecting braking feel and performance. Therefore, a key technical problem to be solved by those skilled in the art is how to design a quick-connect structure with a sufficiently small outer diameter and a sufficiently large inner diameter of the internal oil passage to meet braking performance requirements, while complying with the threading hole size limitation. To this end, we propose an oil pipe quick-connect structure and a hydraulic disc brake system.

### SUMMARY

The embodiments of the present disclosure provide an oil pipe quick-connect structure and a hydraulic disc brake system, aiming to solve at least the problems in the prior art where installing an oil pipe joint typically requires a wrench to tighten the joint screw, causing internal components to deform to form a seal, which poses a risk of oil leakage and is relatively time-consuming and labor-intensive.

In a first aspect, an embodiment of the present disclosure provides an oil pipe quick-connect structure, comprising a first oil pipe which is hollow, a connecting piece, an adapter piece, and an elastic piece for axially positioning the connecting piece and the adapter piece, wherein the connecting piece and the adapter piece are internally provided with an oil path, a first end of the connecting piece is fixed on a free end of the first oil pipe, and a second end of the connecting piece is engaged with the adapter piece;
the connecting piece comprises a first plug-in portion, and a snap portion arranged on a side wall of the first plug-in portion;
the adapter piece comprises:
a main body portion, which is hollow and axially provided with a first accommodating cavity, a second accommodating cavity, and a third accommodating cavity sequentially arranged and mutually communicated;
a bayonet portion, which is opened on a side wall surface of the first accommodating cavity and communicates with the second accommodating cavity, to allow the snap portion to pass through the bayonet portion and be rotationally positioned within the second accommodating cavity;
wherein, an inner diameter of the third accommodating cavity is smaller than an inner diameter of the first accommodating cavity, and the inner diameter of the first accommodating cavity is smaller than an inner diameter of the second accommodating cavity, and an outer edge diameter of the snap portion is smaller than the inner diameter of the second accommodating cavity and larger than the inner diameter of the first accommodating cavity.

Optionally, the adapter piece further comprises:
a locking piece, fixedly assembled on an outer wall of the main body portion, and provided with a portion extending into the second accommodating cavity to limit a rotation angle of the snap portion.

Optionally, the connecting piece further comprises:
a second plug-in portion, arranged at a second end of the first plug-in portion and having an outer diameter smaller than that of the first plug-in portion, wherein a first sealing ring is radially assembled on an outer side wall of the second plug-in portion, the first sealing ring abutting against and sealing an inner wall of the third accommodating cavity;
an annular edge portion, arranged between the first plug-in portion and a first oil needle portion to limit the first oil pipe, wherein the first oil needle portion is arranged on the first end of the connecting piece, and an oil pipe sleeve for externally compressing and fixing the first oil needle portion and the first oil pipe is assembled on the free end of the first oil pipe;
an extension portion, integrally formed at one end of the second plug-in portion facing away from the first plug-in portion.

Optionally, the snap portion comprises: main snap portions, at least one in number and arranged on an annular side wall of the first plug-in portion near the second plug-in portion;
auxiliary snap portions, at least one in number, arranged on the annular side wall of the first plug-in portion near the second plug-in portion and circumferentially staggered relative to the first plug-in portion, having a same width as the main snap portions, and having a length greater than that of the main snap portions and smaller than a height of the second accommodating cavity;
the bayonet portion comprises:
main bayonet portions, opened on the side wall surface of the first accommodating cavity and communicating with the second accommodating cavity, the number of which matches the number of the main snap portions;
auxiliary bayonet portions, opened on the side wall surface of the first accommodating cavity and communicating with the second accommodating cavity, the number of which matches the number of the auxiliary snap portions.

Optionally, a first oil needle portion is provided on the first end of the connecting piece, and an oil pipe sleeve for externally compressing and fixing the first oil needle portion and the first oil pipe is assembled on the free end of the first oil pipe.

Optionally, the elastic piece comprises:
a fourth accommodating cavity, provided in an inner cavity of the main body portion near its second end and communicating with the third accommodating cavity, wherein an inner diameter of the fourth accommodating cavity is smaller than the inner diameter of the third accommodating cavity;
a positioning block, movably assembled within the fourth accommodating cavity, having a first end abutting the extension portion, and a diameter larger than the inner diameter of the third accommodating cavity, and having a second end formed with a spring sleeve portion;
a positioning spring, sleeved on the spring sleeve portion to elastically position the positioning block at a step where the fourth accommodating cavity meets the third accommodating cavity.

Optionally, the main body portion comprises:
a first adapter body, axially provided with the first accommodating cavity, the second accommodating cavity, and the third accommodating cavity, and having an external threaded portion at its second end;
a second adapter body, axially provided with the fourth accommodating cavity, and having an internal threaded portion in its inner cavity near one end of the first adapter body, wherein the internal threaded portion is threadedly connected to the external threaded portion to connect the first adapter body and the second adapter body to form the main body portion.

Optionally, a third sealing ring is provided between the first adapter body and the second adapter body.

Optionally, the adapter piece is assembled on a connection end of an upper brake pump and a lower brake pump via a union mechanism and communicates with the oil paths of the upper brake pump and the lower brake pump, the union mechanism comprising:
an adapter step, integrally formed on an annular side wall of the main body portion near its second end;
a union sleeve, movably sleeved on the annular side wall of the main body portion, and abutting against the adapter step for axial limitation after being assembled with the first end of the main body portion, having an outer annular wall provided with external threads matching preset internal threads within the connection end;
wherein, an end of the union sleeve near the connecting piece is formed with a hexagonal screw head portion for cooperating with a wrench tool.

Optionally, wherein a second sealing ring is radially assembled on an outer side wall of the main body portion near its second end, the second sealing ring abutting against and sealing an inner wall surface of the connection end.

Optionally, a second oil needle portion is integrally formed at a second end of the adapter piece, and the second oil needle portion is inserted and fixed inside a second oil pipe which is hollow, to connect the oil path of the first oil pipe and the second oil pipe after a snap-and-twist quick-connection.

In a second aspect, an embodiment of the present disclosure provides a hydraulic disc brake system, which comprises the oil pipe quick-connect structure according to the first aspect.

Compared with related technologies, the oil pipe quick-connect structure and hydraulic disc brake system provided by the embodiments of the present disclosure have at least the following technical effects:

By rotating the connecting piece and the adapter piece for quick-connection and positioning the snap portion, the auxiliary snap portion can be snapped into the main bayonet portion under the elastic force of the elastic piece, while the main snap portion is axially positioned by the step formed at the junction between the first accommodating cavity and the second accommodating cavity, completing the snap-and-twist quick-connection. At this point, both axial and circumferential quick-connection positioning of the connecting piece and the adapter piece are achieved, the oil path is unobstructed and leak-free, enabling convenient quick-connection of the oil pipe joint without the need for auxiliary tools, and preventing easy detachment, greatly facilitating rapid assembly of the oil pipe within the hydraulic disc brake system. This structure is suitable for compensating for insufficient oil pipe length in the hydraulic disc brake system. It can also be combined with the overall structure of an upper brake pump and/or lower brake pump having the adapter piece structure. The assembly of the union sleeve on the main body portion allows the main body portion to rotate freely after the adapter piece is assembled to the connection end of the upper brake pump and the lower brake pump. Combined with the arrangement of the main snap portion and auxiliary snap portion on the connecting piece, after inserting the connecting piece into the inner cavity of the adapter piece, the main body portion can be conveniently rotated, eliminating the need to rotate the first oil pipe and connecting piece which are difficult to rotate after internal threading, thereby increasing ease of installation and user-friendliness.

The present disclosure optimizes the structural design of the connecting piece and the adapter piece, controlling the maximum outer diameter of the quick-connect structure to below 6.5 mm, solving the problem of limited installation space inside the frame. Its small outer diameter (smaller than 6.5 mm) is smaller than the standard 7 mm threading hole of bicycle frames, providing sufficient tolerance space for installation, greatly reducing threading resistance, making the threading of the oil pipe inside the frame very easy, and avoiding installation jams caused by interference fit. Furthermore, by optimizing the structural design of the connecting piece and adapter piece to keep the maximum outer diameter below 6.5 mm, the issue of limited installation space inside the frame is solved. Simultaneously, through specific internal flow channel design (e.g., layout of the first oil groove and the second oil groove), the internal flow channel diameter is maintained above 1.5 mm, ensuring the smoothness of the brake oil path, meeting the oil flow demand of the hydraulic disc brake system, and avoiding brake sponginess or response delay caused by diameter reduction.

### BRIEF DESCRIPTION OF THE DRAWINGS

FIG. 1 is a perspective view of an oil pipe quick-connect structure according to an exemplary embodiment.

FIG. 2 is an exploded view of the oil pipe quick-connect structure according to an exemplary embodiment.

FIG. 3 is an exploded cross-sectional view of the oil pipe quick-connect structure according to an exemplary embodiment.

FIG. 4 is a figure showing an assembly process of the oil pipe quick-connect structure according to an exemplary embodiment.

FIG. 5 is a figure showing an assembly process of the oil pipe quick-connect structure according to an exemplary embodiment.

FIG. 6 is a figure showing an assembly process of the oil pipe quick-connect structure according to an exemplary embodiment.

FIG. 7 is a perspective view of the oil pipe quick-connect structure according to a second exemplary embodiment.

FIG. 8 is a cross-sectional view of the oil pipe quick-connect structure according to the second exemplary embodiment.

FIG. 9 is an exploded view of the oil pipe quick-connect structure according to the second exemplary embodiment.

FIG. 10 is an assembly figure of the oil pipe quick-connect structure according to the second exemplary embodiment.

FIG. 11 is an assembly figure of the pump body as manufactured according to the second exemplary embodiment.

FIG. 12 is a structural figure of an adapter sealing plug according to the second exemplary embodiment.

FIG. 13 is a perspective view of the oil pipe quick-connect structure according to a third exemplary embodiment.

FIG. 14 is an exploded view of the oil pipe quick-connect structure according to the third exemplary embodiment.

### DESCRIPTION OF REFERENCE NUMERALS

Connecting piece 10: First plug-in portion 101; Second plug-in portion 102; Extension portion 103; First oil needle portion 104; Main snap portion 1051; Auxiliary snap portion 1052; First sealing ring 106; Annular edge portion 107;
Adapter piece 20: Main body portion 201; First adapter body 2011; External threaded portion 2012; Second adapter body 2013; Second oil needle portion 2014; Third sealing ring 2015; First accommodating cavity 2021; Second accommodating cavity 2022; Third accommodating cavity 2023; Main bayonet portion 2024; Auxiliary bayonet portion 2025; Fourth accommodating cavity 2026; Locking piece 203; Buckle head portion 2031; Adapter step 204; Second sealing ring 205; Union sleeve 206; Hexagonal screw head portion 2061; Second oil needle portion 2014;
First oil pipe 30; Oil pipe sleeve 40; Elastic piece 50; Positioning block 501; Spring sleeve portion 502; Positioning spring 503; Second oil pipe 60;
Adapter sealing plug 70; Handle portion 701.

### DETAILED DESCRIPTION

The present invention will be further described with reference to the drawings and preferred embodiments. It should be understood that these embodiments are only used to illustrate the present invention, but the present invention is not limited thereto. In addition, it should be understood that after reading the content described in the present invention, those skilled in the art can make various changes or modifications to the present invention, and these equivalent technical means also fall within the scope of protection of the present invention.

In the present invention, the terms “first,” “second,” and “third” are merely for the purpose of description, but cannot be understood as indicating or implying relative importance. The term “multiple” means two or more unless otherwise explicitly defined. The terms “mount,” “connect with,” “connect,” “fix,” and the like shall be understood in a broad sense. For example, “connect” may mean being fixedly connected, detachably connected, or integrally connected; and “connect with” may mean being directly connected or indirectly connected through an intermediary. For those of ordinary skill in the art, specific meanings of the above terms in the present invention can be understood according to specific situations.

In the description of the present invention, it should be understood that if orientation or position relations indicated by the terms such as “upper,” “lower,” “left,” “right,” “front,” “back,” and the like are based on the orientation or position relations shown in the drawings, and the terms are intended only to facilitate the description of the present invention and simplify the description, rather than indicating or implying that the apparatus or element referred to must have a particular orientation and be constructed and operated in the particular orientation, and therefore cannot be construed as a limitation on the present invention.

In related technologies, when installing a brake system on an internally routed bicycle, the high-pressure oil pipe connected to the upper brake pump and the lower brake pump needs to pass through the interior of the bicycle frame and connect to the upper brake pump and the lower brake pump at the other end. Since the oil pipe is pre-filled with brake fluid, the joints at both ends of the oil pipe are sealed. A common sealing method is surface sealing. After the oil pipe is threaded through the frame, installation of the oil pipe joint typically requires a wrench to tighten the joint screw, causing internal components to deform to form a seal. However, this method requires applying a set torque with a wrench, insufficient torque will result in the oil leakage risk, and the process is relatively time-consuming and labor-intensive.

Thus, embodiments of the present disclosure provide an oil pipe quick-connect structure and a hydraulic disc brake system, which are described in detail below with reference to specific embodiments and drawings.

### Embodiment 1

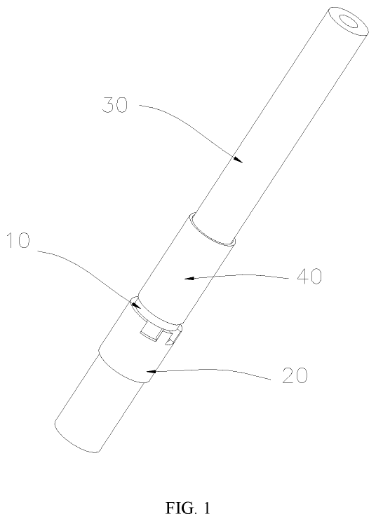

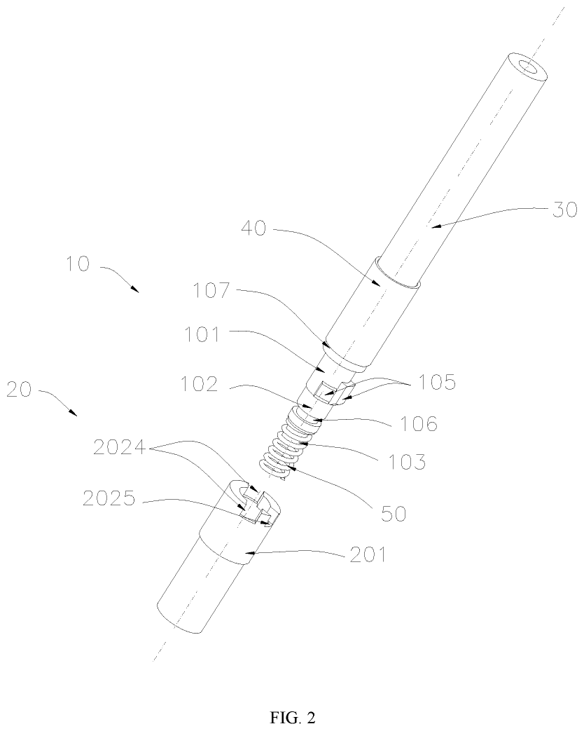

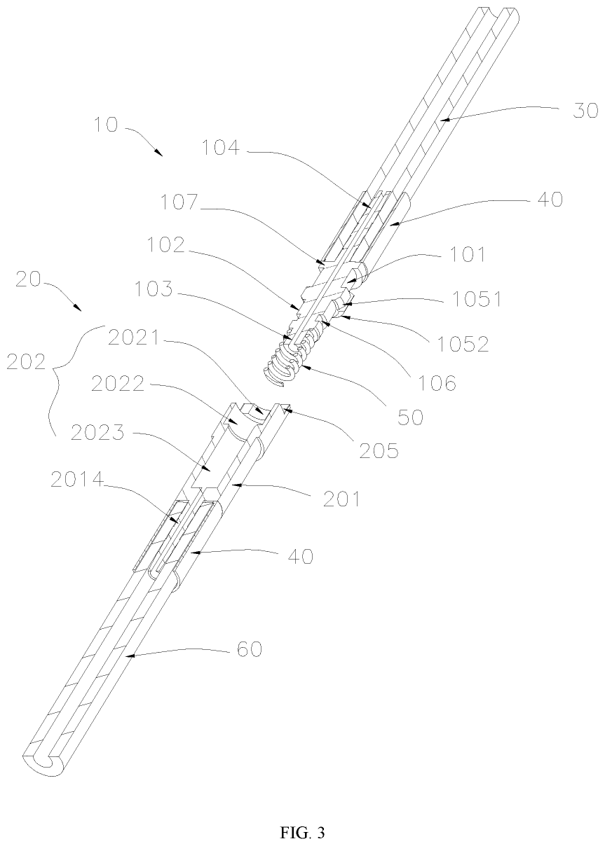

An embodiment of the present disclosure provides an oil pipe quick-connect structure. FIG. 1 is a perspective view of the oil pipe quick-connect structure according to an exemplary embodiment. FIG. 2 is an exploded view of the oil pipe quick-connect structure according to an exemplary embodiment. FIG. 3 is an exploded cross-sectional view of the oil pipe quick-connect structure according to an exemplary embodiment. As shown in FIGS. 1-3, the oil pipe quick-connect structure comprises a first oil pipe 30 which is hollow, a connecting piece 10, an adapter piece 20, and an elastic piece 50 for axially positioning an assembly position of the connecting piece 10 and the adapter piece 20. Both the connecting piece 10 and the adapter piece 20 internally have an oil path. A first end of the connecting piece 10 is fixed on a free end of the first oil pipe 30, and a second end of the connecting piece 10 is engaged with the adapter piece 20 to communicate with the oil path. In this embodiment, a first oil needle portion 104 is provided on the first end of the connecting piece 10, and an oil pipe sleeve 40 for externally compressing and fixing the first oil needle portion 104 and the first oil pipe 30 is assembled on the free end of the first oil pipe 30.

In this embodiment, further referring to FIGS. 1-3, the connecting piece 10 at least comprises a first plug-in portion 101, and a snap portion arranged on a side wall of the first plug-in portion 101. In this embodiment, the snap portion comprises: main snap portions 1051, two in number and symmetrically distributed, arranged on an annular side wall of the first plug-in portion 101 near the second plug-in portion 102; auxiliary snap portions 1052, at least one in number and arranged on the annular side wall of the first plug-in portion 101 near the second plug-in portion 102 and circumferentially staggered relative to the first plug-in portion 101, having a same width as the main snap portions 1051, and having a length greater than that of the main snap portions 1051 and smaller than a height of the second accommodating cavity 2022, with the end near the second plug-in portion 102 being flush with the first end of the main snap portions 1051.

Further, the connecting piece 10 also comprises: a second plug-in portion 102, arranged at a second end of the first plug-in portion 101 and having an outer diameter smaller than that of the first plug-in portion 101, wherein a first sealing ring 106 is radially assembled on an outer side wall of the second plug-in portion 102, the first sealing ring 106 abutting against and sealing an inner wall of the third accommodating cavity 2023; the first sealing ring 106 creates a seal between the inner cavity of the third accommodating cavity 2023, the sealing ring 106, and the outer wall of the second plug-in portion 102, effectively maintaining an unobstructed oil path and preventing oil leakage.

An annular edge portion 107 is arranged between the first plug-in portion 101 and the first oil needle portion 104 to limit the assembly position of the first oil pipe 30. It is understandable that it is used not only for positioning after the first oil needle portion 104 is inserted into the first oil pipe 30, but also for axially positioning the first plug-in portion 101 of the connecting piece 10 after it enters the interior of the adapter piece 20.

An extension portion 103 is integrally formed at one end of the second plug-in portion 102 facing away from the first plug-in portion 101.

The adapter piece 20 at least comprises: a main body portion 201, which is hollow and axially provided with a first accommodating cavity 2021, a second accommodating cavity 2022, and a third accommodating cavity 2023 arranged sequentially and mutually communicated;

A bayonet portion, opened on a side wall surface of the first accommodating cavity 2021 and communicating with the second accommodating cavity 2022, to allow the snap portion to pass through the bayonet portion and be engaged and positioned after rotating within the second accommodating cavity 2022. In this embodiment, the bayonet portion comprises: main bayonet portions 2024, opened on the side wall surface of the first accommodating cavity 2021 and communicating with the second accommodating cavity 2022, the number of which matches the number of the main snap portions 1051; auxiliary bayonet portions 2025, opened on the side wall surface of the first accommodating cavity 2021 and communicating with the second accommodating cavity 2022, the number of which matches the number of the auxiliary snap portions 1052.

Wherein, the inner diameter R3 of the third accommodating cavity 2023 is smaller than the inner diameter R1 of the first accommodating cavity 2021, and the inner diameter R1 of the first accommodating cavity 2021 is smaller than the inner diameter R2 of the second accommodating cavity 2022, and the outer edge diameter of the snap portion is smaller than the inner diameter R2 of the second accommodating cavity 2022 and larger than the inner diameter R1 of the first accommodating cavity 2021. It is understandable that the diameter of the first plug-in portion 101 corresponds to the inner diameter R1 of the first accommodating cavity 2021, and the diameter of the second plug-in portion 102 corresponds to the inner diameter R3 of the third accommodating cavity 2023. Thus, after insertion, the edge of the first plug-in portion 101 abuts the step between the second accommodating cavity 2022 and the third accommodating cavity 2023, providing axial positioning.
further referring to FIGS. 1-3, in this embodiment, the outer diameters of the connecting piece 10 and the adapter piece 20 are smaller than traditional fixed oil needles and are relatively regular, making them more convenient for threading and assembling the oil pipe within internally routed bicycle frames.
further referring to FIGS. 1-3, in this embodiment, the elastic piece 50 comprises:
a positioning spring, having a first end sleeved on the extension portion 103, and having its other end abutting the inner wall of the third accommodating cavity 2023 after the first plug-in portion 101 is installed into the second accommodating cavity 2022, providing an axial positioning force.

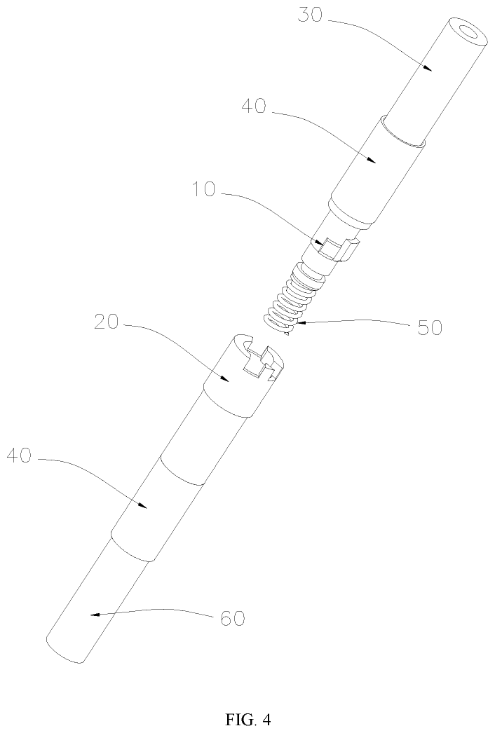

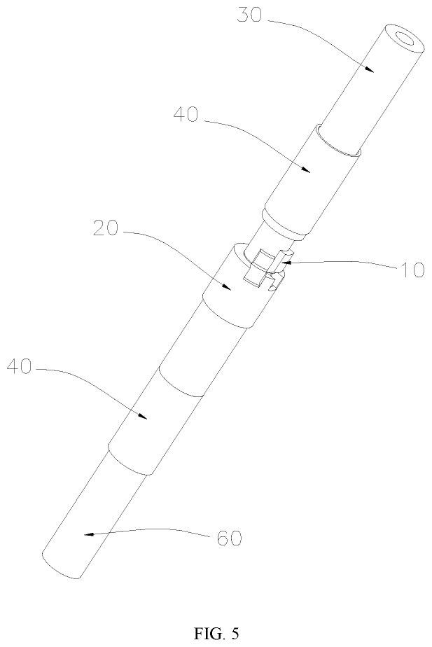

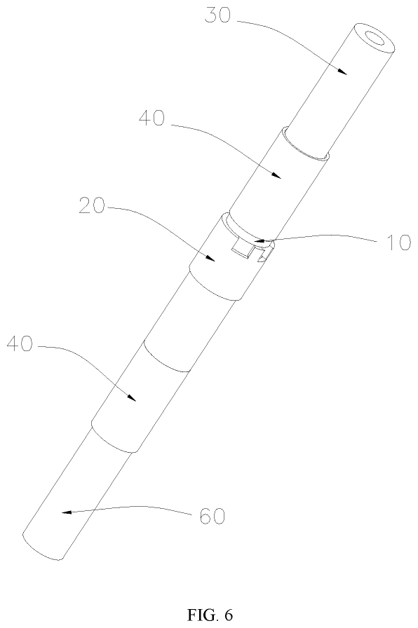

FIG. 4 is a figure showing an assembly process of the oil pipe quick-connect structure according to an exemplary embodiment. FIG. 5 is a figure showing an assembly process of the oil pipe quick-connect structure according to an exemplary embodiment. FIG. 6 is a figure showing an assembly process of the oil pipe quick-connect structure according to an exemplary embodiment. Referring to FIGS. 1-6, in this embodiment:
Step 1: The first oil needle portion 104 of the connecting piece 10 is inserted into the free end of the first oil pipe 30 and externally compressed and fixed by the oil pipe sleeve 40. It is understandable that the fixing principle of the oil pipe sleeve 40 is that after the first oil needle portion 104 is pressed into the free end of the first oil pipe 30, an external pressing machine applies pressure to the outside of the oil pipe sleeve 40 to deform the sleeve, thereby fixing the first oil needle portion 104 and the first oil pipe 30. The positioning spring is then installed on the extension portion 103 of the connecting piece 10.
Step 2: Aligning the connecting piece 10 with the adapter piece 20, aligning the main snap portions 1051 with the main bayonet portions 2024 and the auxiliary snap portions 1052 with the auxiliary bayonet portions 2025, then inserting.
Step 4: Once the main snap portions 1051 and auxiliary snap portions 1052 have entered the second accommodating cavity 2022, rotating the main body portion 201 clockwise or counterclockwise until the auxiliary snap portions 1052 rotate to one of the main bayonet portions 2024. Releasing the applied pressure, and the auxiliary snap portions 1052 will snap into the main bayonet portion 2024 under the elastic force of the positioning spring. The main snap portions 1051 are then axially positioned by the step formed at the junction between the first accommodating cavity 2021 and the second accommodating cavity 2022. At this point, both axial and circumferential quick-connection positioning of the connecting piece 10 and the adapter piece 20 are achieved, without needing auxiliary tool fixation and preventing detachment, facilitating installation of the oil pipe within the hydraulic disc brake system.

In summary, the oil pipe quick-connect structure provided in Embodiment 1 of the present disclosure, through the rotational quick-connection of the connecting piece 10 and the adapter piece 20, and the arrangement of the main snap portions 1051 and auxiliary snap portions 1052, allows the auxiliary snap portions 1052 to snap into the main bayonet portions 2024 under the elastic force of the positioning spring after rotational quick-connection, while the main snap portions 1051 are axially positioned by the step formed at the junction between the first accommodating cavity 2021 and the second accommodating cavity 2022. At this point, both axial and circumferential quick-connection positioning of the connecting piece 10 and the adapter piece 20 are achieved, the oil path is unobstructed and leak-free, enabling quick, convenient, and reliable connection without auxiliary tools, greatly facilitating rapid assembly of the oil pipe within the hydraulic disc brake system.

### Embodiment 2

Currently, some oil pipe joint products on the market allow rotational quick-assembly of the oil pipe joint with the upper brake pump and the lower brake pump. However, during assembly of these products, the joint piece connected to the oil pipe generally needs to be rotated. But it is difficult to rotate the oil pipe after it has been threaded through the frame. Furthermore, during quick-connection, it is also difficult to accurately determine the rotation angle required for the actively rotating joint piece to position within the other joint piece, resulting in slightly poor convenience.

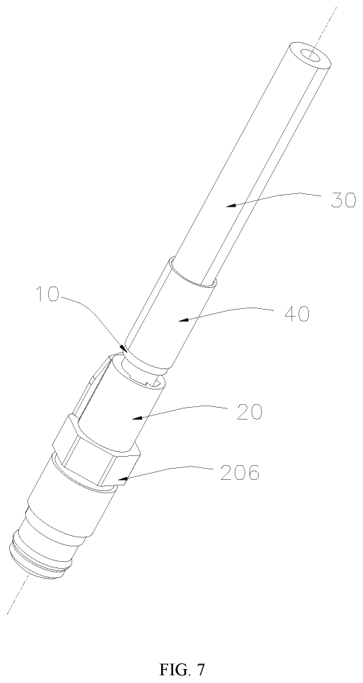

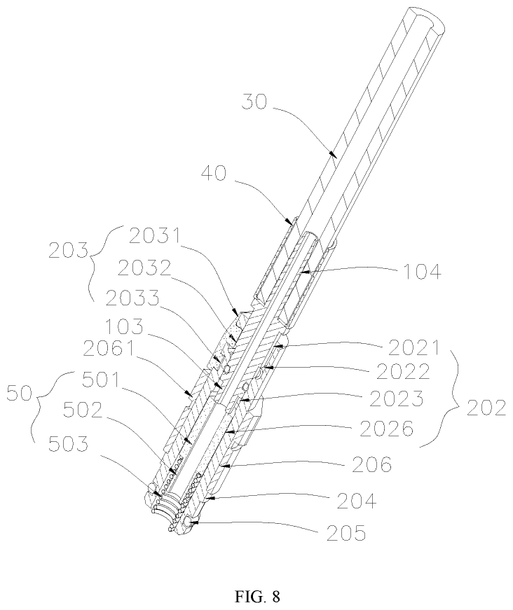

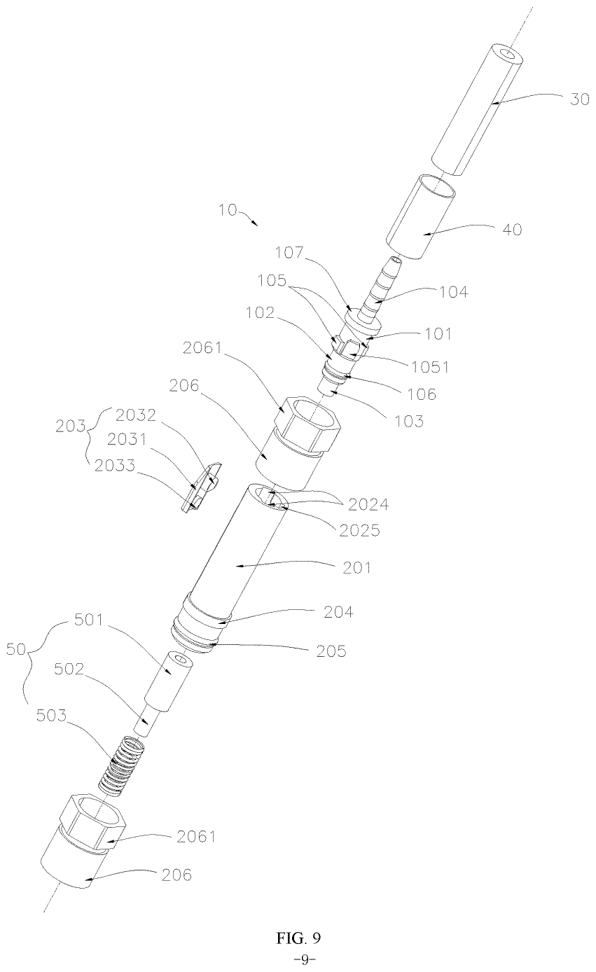

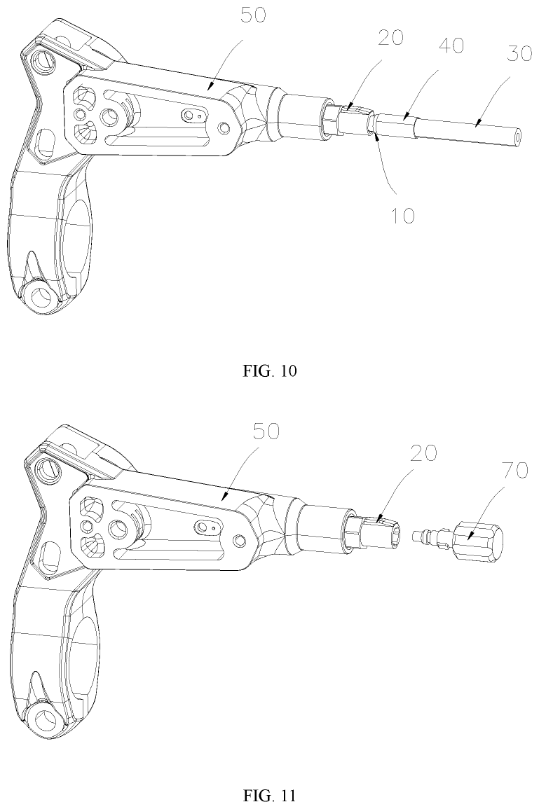

Thus, the difference between Embodiment 2 and Embodiment 1 is that Embodiment 2 of the present disclosure provides another oil pipe quick-connect structure. FIG. 7 is a perspective view of the oil pipe quick-connect structure according to a second exemplary embodiment. FIG. 8 is a cross-sectional view of the oil pipe quick-connect structure according to the second exemplary embodiment. FIG. 9 is an exploded view of the oil pipe quick-connect structure according to the second exemplary embodiment. FIG. 10 is an assembly figure of the oil pipe quick-connect structure according to the second exemplary embodiment. Referring to FIGS. 7-10, the oil pipe quick-connect structure comprises a first oil pipe 30 which is hollow, a connecting piece 10, an adapter piece 20, and an elastic piece 50 for axially positioning an assembly position of the connecting piece 10 and the adapter piece 20. Both the connecting piece 10 and the adapter piece 20 internally have an oil path. A first end of the connecting piece 10 is fixed on a free end of the first oil pipe 30, and a second end of the connecting piece 10 is engaged with the adapter piece 20 to communicate with the oil path. In this embodiment, a first oil needle portion 104 is provided on the first end of the connecting piece 10, and an oil pipe sleeve 40 for externally compressing and fixing the first oil needle portion 104 and the first oil pipe 30 is assembled on the free end of the first oil pipe 30.

In this embodiment, further referring to FIGS. 7-10, the connecting piece 10 at least comprises a first plug-in portion 101, and a snap portion arranged on a side wall of the first plug-in portion 101. In this embodiment, the snap portion comprises: main snap portions 1051, two in number and symmetrically distributed, arranged on an annular side wall of the first plug-in portion 101 near the second plug-in portion 102; auxiliary snap portions 1052, at least one in number and arranged on the annular side wall of the first plug-in portion 101 near the second plug-in portion 102 and circumferentially staggered relative to the first plug-in portion 101, having a same width as the main snap portions 1051, and having a length greater than that of the main snap portions 1051 and smaller than a height of the second accommodating cavity 2022, with the end near the second plug-in portion 102 being flush with the first end of the main snap portions 1051.

Further, the connecting piece 10 also comprises: a second plug-in portion 102, arranged at a second end of the first plug-in portion 101 and having an outer diameter smaller than that of the first plug-in portion 101, wherein a first sealing ring 106 is radially assembled on an outer side wall of the second plug-in portion 102, the first sealing ring 106 abutting against and sealing an inner wall of the third accommodating cavity 2023; the first sealing ring 106 creates a seal between the inner cavity of the third accommodating cavity 2023, the sealing ring 106, and the outer wall of the second plug-in portion 102, effectively maintaining an unobstructed oil path and preventing oil leakage.

An annular edge portion 107 is arranged between the first plug-in portion 101 and the first oil needle portion 104 to limit the assembly position of the first oil pipe 30. It is understandable that it is used not only for positioning after the first oil needle portion 104 is inserted into the first oil pipe 30, but also for axially positioning the first plug-in portion 101 of the connecting piece 10 after it enters the interior of the adapter piece 20.

An extension portion 103 is integrally formed at one end of the second plug-in portion 102 facing away from the first plug-in portion 101.

The adapter piece 20 at least comprises: a main body portion 201, which is hollow and axially provided with a first accommodating cavity 2021, a second accommodating cavity 2022, and a third accommodating cavity 2023 arranged sequentially and mutually communicated;

A bayonet portion, opened on a side wall surface of the first accommodating cavity 2021 and communicating with the second accommodating cavity 2022, to allow the snap portion to pass through the bayonet portion and be engaged and positioned after rotating within the second accommodating cavity 2022. In this embodiment, the bayonet portion comprises: main bayonet portions 2024, opened on the side wall surface of the first accommodating cavity 2021 and communicating with the second accommodating cavity 2022, the number of which matches the number of the main snap portions 1051; auxiliary bayonet portions 2025, opened on the side wall surface of the first accommodating cavity 2021 and communicating with the second accommodating cavity 2022, the number of which matches the number of the auxiliary snap portions 1052.

A locking piece 203 is fixedly assembled on an outer wall of the main body portion 201, and is provided with a portion extending into the second accommodating cavity 2022 to limit the rotation angle of the snap portion.

Wherein, the inner diameter R3 of the third accommodating cavity 2023 is smaller than the inner diameter R1 of the first accommodating cavity 2021, the inner diameter R1 of the first accommodating cavity 2021 is smaller than the inner diameter R2 of the second accommodating cavity 2022, and the outer edge diameter of the snap portion is smaller than the inner diameter R2 of the second accommodating cavity 2022 and larger than the inner diameter R1 of the first accommodating cavity 2021. It is understandable that the diameter of the first plug-in portion 101 corresponds to the inner diameter R1 of the first accommodating cavity 2021, and the diameter of the second plug-in portion 102 corresponds to the inner diameter R3 of the third accommodating cavity 2023. Thus, after insertion, the edge of the first plug-in portion 101 abuts the step between the second accommodating cavity 2022 and the third accommodating cavity 2023, providing axial positioning.

Further referring to FIGS. 7-10, in this embodiment, the outer diameters of the connecting piece 10 and the adapter piece 20 are smaller than traditional fixed oil needles and are relatively regular, making them more convenient for threading and assembling the oil pipe within internally routed bicycle frames.

Further referring to FIGS. 7-10, in this embodiment, the elastic piece 50 comprises: a fourth accommodating cavity 2026, provided in an inner cavity of the main body portion 201 near its second end and communicating with the third accommodating cavity 2023, wherein the inner diameter R4 of the fourth accommodating cavity 2026 is smaller than the inner diameter R3 of the third accommodating cavity 2023.

A positioning block 501 is movably assembled within the fourth accommodating cavity 2026. A first end of the positioning block 501 abuts the extension portion 103, and its diameter is larger than the inner diameter R3 of the third accommodating cavity 2023. A second end of the positioning block 501 is formed with a spring sleeve portion 502.

A positioning spring 503 is sleeved on the spring sleeve portion 502 to elastically position the positioning block 501 at a step where the fourth accommodating cavity 2026 meets the third accommodating cavity 2023.

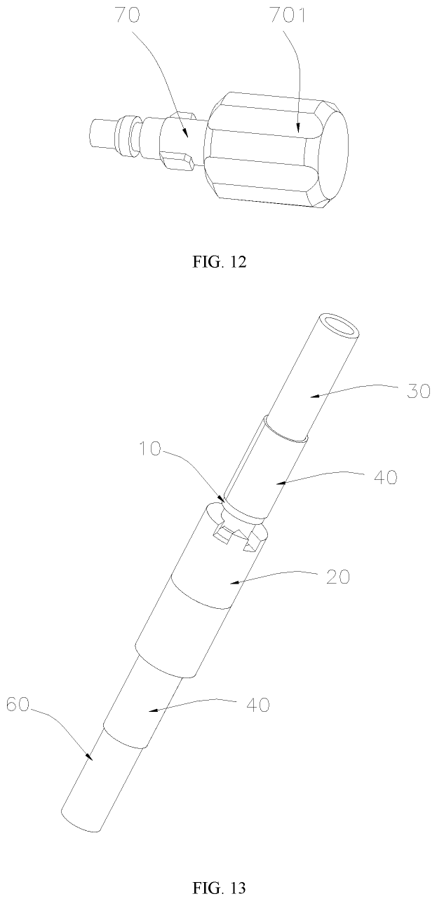

FIG. 11 is an assembly figure of the pump body as manufactured according to the second exemplary embodiment. FIG. 12 is a structural figure of an adapter sealing plug according to the second exemplary embodiment. Referring to FIGS. 7-12, in this embodiment, the adapter piece 20 is assembled on a connection end of an upper brake pump and a lower brake pump via a union mechanism and communicates with the oil paths of the upper brake pump and the lower brake pump. The union mechanism comprises:
an adapter step 204, integrally formed on an annular side wall of the main body portion 201 near its second end;
a union sleeve 206, movably sleeved on the annular side wall of the main body portion 201, and abutting against the adapter step 204 for axial limitation after being assembled with the first end of the main body portion 201, having an outer annular wall provided with external threads matching preset internal threads within the connection end;
wherein, an end of the union sleeve 206 near the connecting piece 10 is formed with a hexagonal screw head portion 2061 for cooperating with a wrench tool; a second sealing ring 205 is radially assembled on an outer side wall of the main body portion 201 near its second end, the second sealing ring 205 abutting against and sealing an inner wall surface of the connection end.

In the technical solution of the above embodiment, referring to FIGS. 7-12:
Step 1: assembling the union sleeve 206 onto the first end of the adapter piece 20. Then, assembling the positioning spring 503 onto the spring sleeve portion 502 of the positioning block 501, and then inserting it into the fourth accommodating cavity 2026 from the second end of the adapter piece 20. Subsequently, inserting the second end of the adapter piece 20 into the connection end of the upper brake pump and the lower brake pump. The second sealing ring 205 abuts and seals. Tightening the union sleeve 206 onto the connection end of the upper brake pump and the lower brake pump via threads, completing the assembly of the adapter piece 20. At this point, the main body portion 201 can rotate freely inside the connection end, and the elastic piece 50 is confined and cannot detach.
Step 2: The first oil needle portion 104 of the connecting piece 10 is inserted into the free end of the first oil pipe 30 and externally compressed and fixed by the oil pipe sleeve 40. It is understandable that the fixing principle of the oil pipe sleeve 40 is that after the first oil needle portion 104 is pressed into the free end of the first oil pipe 30, an external pressing machine applies pressure to the outside of the oil pipe sleeve 40 to deform the sleeve, thereby fixing the first oil needle portion 104 and the first oil pipe 30.
Step 3: Aligning the connecting piece 10 with the adapter piece 20, aligning the main snap portions 1051 with the main bayonet portions 2024 and the auxiliary snap portions 1052 with the auxiliary bayonet portions 2025, then inserting.
Step 4: Once the main snap portions 1051 and auxiliary snap portions 1052 have entered the second accommodating cavity 2022, rotate the main body portion 201 clockwise or counterclockwise. The assembly position of the buckle head portion 2031 is set based on pre-calculated positions. Rotating until one of the snap portions (auxiliary snap portion 1052) reaches the buckle head portion 2031 of the locking piece 203, completing the positioning of the rotational position. At this time, the auxiliary snap portion 1052 precisely corresponds to one of the main bayonet portions 2024. Releasing the applied pressure, the auxiliary snap portion 1052 will retract axially under the elastic force of the elastic piece 50 (comprising the positioning spring 503 and the positioning block 501) into the main bayonet portion 2024 to engage. The main snap portions 1051 are then axially positioned by the step formed at the junction between the first accommodating cavity 2021 and the second accommodating cavity 2022. At this point, both axial and circumferential snap-and-twist quick-connection positioning of the connecting piece 10 and the adapter piece 20 are achieved, without needing auxiliary tool fixation and preventing detachment, facilitating installation of the oil pipe within the hydraulic disc brake system.

Referring to FIG. 11, it is understandable that is an assembly figure of the pump body as manufactured according to an exemplary embodiment. FIG. 12 is a structural figure of the adapter sealing plug according to an exemplary embodiment. The adapter sealing plug 70 has the same plug-in positioning structure as the second end of the connecting piece 10, i.e., the first plug-in portion 101, second plug-in portion 102, extension portion 103, main snap portions 1051, auxiliary snap portions 1052, first sealing ring 106, and a handle portion 701 provided at the second end of the first plug-in portion 101.

When assembled and leaving the factory, after the pump body is filled with oil, the first end of the adapter sealing plug 70 is inserted into the adapter piece 20. Then, the main body portion 201 or the handle portion 701 is rotated clockwise or counterclockwise. The auxiliary snap portion of the adapter sealing plug 70 retracts axially under the elastic force of the elastic piece 50 into one of the main bayonet portions 2024 to engage. The main snap portion of the adapter sealing plug 70 is axially positioned by the step formed at the junction between the first accommodating cavity 2021 and the second accommodating cavity 2022. At this point, both axial and circumferential snap-and-twist quick-connection positioning of the adapter sealing plug 70 and the adapter piece 20 are achieved, without needing auxiliary tool fixation and preventing detachment, completing the assembly and factory shipment of the pump body after oil filling.

In summary, the oil pipe quick-connect structure provided in Embodiment 2 of the present disclosure, through the rotational quick-connection of the connecting piece 10 and the adapter piece 20 and the positioning of the snap portion by the locking piece 203, allows the auxiliary snap portions 1052 to snap into the main bayonet portions 2024 under the elastic force of the elastic piece 50, while the main snap portions 1051 are axially positioned by the step formed at the junction between the first accommodating cavity 2021 and the second accommodating cavity 2022, completing the snap-and-twist quick-connection. At this point, both axial and circumferential quick-connection positioning of the connecting piece 10 and the adapter piece 20 are achieved, the oil path is unobstructed and leak-free, enabling convenient quick-connection of the oil pipe joint after positioning without the need for auxiliary tools and without the need to rotate the connecting piece 10, and preventing easy detachment, greatly facilitating rapid assembly of the oil pipe within the hydraulic disc brake system. This structure is suitable for compensating for insufficient oil pipe length in the hydraulic disc brake system. It can also be combined with the overall structure of an upper brake pump and/or lower brake pump having the adapter piece 20. The assembly of the union sleeve 206 on the main body portion 201 allows the main body portion 201 to rotate freely after the adapter piece 20 is assembled to the connection end of the upper brake pump and the lower brake pump. Combined with the arrangement of the main snap portions 1051 and auxiliary snap portions 1052 on the connecting piece 10, after inserting the connecting piece 10 into the inner cavity of the adapter piece 20, the main body portion 201 can be conveniently rotated, eliminating the need to rotate the first oil pipe 30 and connecting piece 10 which are difficult to rotate after internal threading, thereby increasing ease of installation and user-friendliness.

### Embodiment 3

When assembling the oil pipe quick-connect structure of Embodiment 2 described above for connecting the oil pipes, the structure is typically considered for concealed assembly within the frame. However, the volume of the adapter piece 20 is relatively large compared to the frame's internal passage holes, making internal threading difficult.

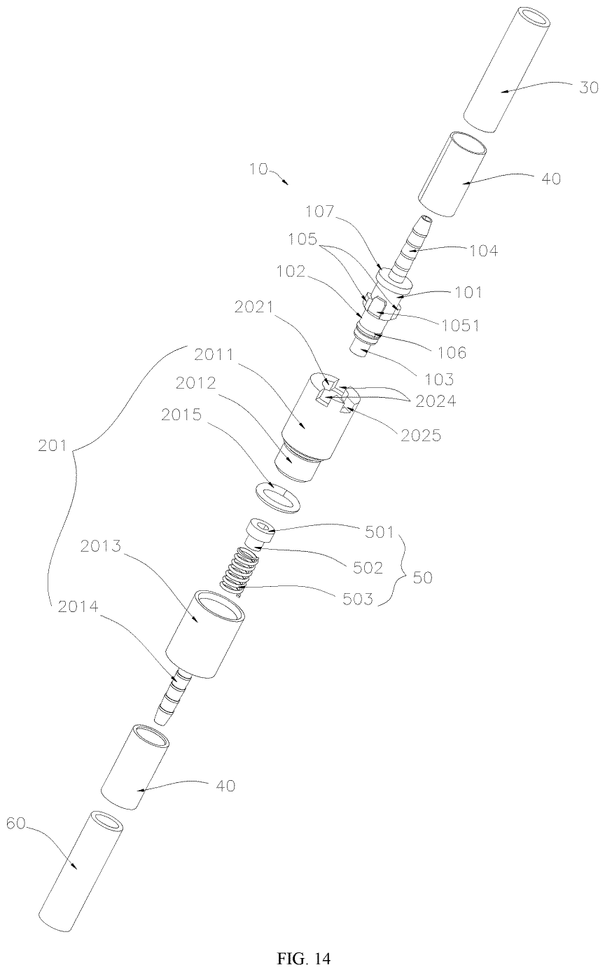

Thus, the difference between Embodiment 3 and Embodiments 1-2 is that Embodiment 3 of the present disclosure provides a third oil pipe quick-connect structure. FIG. 13 is a perspective view of the oil pipe quick-connect structure according to a third exemplary embodiment. FIG. 14 is an exploded view of the oil pipe quick-connect structure according to the third exemplary embodiment. A second oil needle portion 2014 is integrally formed at a second end of the adapter piece 20, and the second oil needle portion 2014 is inserted and fixed inside a second oil pipe 60 which is hollow, to connect the oil path of the first oil pipe 30 and the second oil pipe 60 after a snap-and-twist quick-connection.

Further referring to FIGS. 13-14, the adapter piece 20 is restricted by the volume of the structural parts threaded inside the oil pipe. Therefore, in order to reduce the volume of the adapter piece 20, it is designed as a two-piece structure. Furthermore, the protruding locking piece 203 can be omitted. Internally, it has a same first accommodating cavity 2021, a second accommodating cavity 2022, a third accommodating cavity 2023, and a fourth accommodating cavity 2026 as Embodiment 2, and also comprises:
a first adapter body 2011, axially provided with the first accommodating cavity 2021, the second accommodating cavity 2022, and the third accommodating cavity 2023, and having an external threaded portion 2012 at its second end;
a second adapter body 2013, axially provided correspondingly with the fourth accommodating cavity 2026, and having an internal threaded portion in its inner cavity near one end of the first adapter body 2011, wherein the internal threaded portion is threadedly connected to the external threaded portion 2012 to connect the first adapter body 2011 and the second adapter body 2013 to form the main body portion; a third sealing ring 2015 is provided between the first adapter body 2011 and the second adapter body 2013.

A second oil needle portion 2014 is formed at the second end of the second adapter body 2013. The second oil needle portion 2014 is inserted and fixed inside a second oil pipe 60 which is hollow. An oil pipe sleeve 40 for externally compressing and fixing the second oil needle portion 2014 and the second oil pipe 60 is also assembled on the free end of the second oil pipe 60.

Further referring to FIGS. 13-14, in this embodiment, the outer diameters of the connecting piece 10 and the adapter piece 20 are smaller than traditional fixed oil needles and are relatively regular, making them more convenient for threading and assembling the oil pipe within internally routed bicycle frames.

In summary, the oil pipe quick-connect structure provided by the embodiments of the present disclosure can be used for connection between two oil pipes to extend the oil pipe length in the hydraulic disc brake system, thus compensating for insufficient oil pipe length. This is suitable for unexpected situations during installation as well as for user modifications where the oil pipe length is insufficient.

Please refer to Embodiment 1 for other non-described structures.

### Embodiment 4

Embodiment 4 of the present disclosure provides a hydraulic disc brake system, comprising the oil pipe quick-connect structure according to Embodiment 1 or Embodiment 2 or Embodiment 3.

In summary, the oil pipe quick-connect structure and hydraulic disc brake system provided by the embodiments of the present disclosure, by rotating the connecting piece 10 and the adapter piece 20 for quick-connection and positioning the snap portion via the locking piece 203, allow the auxiliary snap portions 1052 to snap into the main bayonet portions 2024 under the elastic force of the elastic piece 50, while the main snap portions 1051 are axially positioned by the step formed at the junction between the first accommodating cavity 2021 and the second accommodating cavity 2022, completing the snap-and-twist quick-connection. At this point, both axial and circumferential quick-connection positioning of the connecting piece 10 and the adapter piece 20 are achieved, the oil path is unobstructed and leak-free, enabling convenient quick-connection of the oil pipe joint after positioning without the need for auxiliary tools, and preventing easy detachment, greatly facilitating rapid assembly of the oil pipe within the hydraulic disc brake system. This structure is suitable for compensating for insufficient oil pipe length in the hydraulic disc brake system. It can also be combined with the overall structure of an upper brake pump and/or lower brake pump having the adapter piece 20 structure. The assembly of the union sleeve 206 on the main body portion 201 allows the main body portion 201 to rotate freely after the adapter piece 20 is assembled to the connection end of the upper brake pump and the lower brake pump. Combined with the arrangement of the main snap portions 1051 and auxiliary snap portions 1052 on the connecting piece 10, after inserting the connecting piece 10 into the inner cavity of the adapter piece 20, the main body portion 201 can be conveniently rotated, eliminating the need to rotate the first oil pipe 30 and connecting piece 10 which are difficult to rotate after internal threading, thereby increasing ease of installation and user-friendliness.

### Embodiment 5

Based on Embodiments 1-4 described above, Embodiment 5 of the present disclosure further optimizes the external dimensions and internal flow channel parameters of the oil pipe quick-connect structure.

To adapt to the 7 mm threading hole diameter of mainstream internally routed bicycle frames, this embodiment sets the maximum outer diameter of the assembled connecting piece 10 and adapter piece 20 to be less than 6.5 mm. This dimensional design ensures that when the oil pipe joint passes through the frame's threading hole, there is a clearance of at least 0.25 mm on each side, allowing for smooth and unobstructed assembly. Simultaneously, the cross-sectional area of the internal oil path is precisely calculated and verified. By optimizing the inner diameter of the oil passage within the first plug-in portion 101, it is ensured that the inner diameter of the oil passage formed inside the joint remains above 1.5 mm (preferably 1.55 mm to 1.8 mm).

Tests have shown that, while maintaining the standard inner diameter of the oil pipe (e.g., 1.55 mm to 1.6 mm), the quick-connect structure of this embodiment can achieve an oil passage inner diameter of 1.5 mm while controlling the outer diameter below 6.5 mm. This specific parameter combination (outer diameter<6.5 mm, oil passage inner diameter>1.5 mm) has not been disclosed in the prior art and is realized through the self-starting flow channel structure of the present disclosure. It solves the problem of limited installation space while ensuring the response speed and braking force transmission efficiency of the hydraulic system.

Certainly, the above descriptions are merely preferred embodiments of the present disclosure. The present disclosure is not limited to the above embodiments listed. It should be noted that, all equivalent replacements and obvious variations made by any person skilled in the art under the teaching of the specification fall within the essential scope of the specification and shall be protected by the present disclosure.

What is claimed is:

1. An oil pipe quick-connect structure, comprising:
a first oil pipe which is hollow, a connecting piece, an adapter piece, and an elastic piece for axially positioning the connecting piece and the adapter piece, wherein the connecting piece and the adapter piece are internally provided with an oil path, a first end of the connecting piece is fixed on a free end of the first oil pipe, and a second end of the connecting piece is engaged with the adapter piece;
the connecting piece comprises a first plug-in portion, and a snap portion arranged on a side wall of the first plug-in portion;
the adapter piece comprises:
a main body portion, which is hollow and axially provided with a first accommodating cavity, a second accommodating cavity, and a third accommodating cavity sequentially arranged and mutually communicated;
a bayonet portion, which is opened on a side wall surface of the first accommodating cavity and communicates with the second accommodating cavity, to allow the snap portion to pass through the bayonet portion and be rotationally positioned within the second accommodating cavity;
wherein, an inner diameter of the third accommodating cavity is smaller than an inner diameter of the first accommodating cavity, and the inner diameter of the first accommodating cavity is smaller than an inner diameter of the second accommodating cavity, and an outer edge diameter of the snap portion is smaller than the inner diameter of the second accommodating cavity and larger than the inner diameter of the first accommodating cavity.

2. The oil pipe quick-connect structure according to claim 1, wherein the adapter piece further comprises:
a locking piece, fixedly assembled on an outer wall of the main body portion, and provided with a portion extending into the second accommodating cavity to limit a rotation angle of the snap portion.

3. The oil pipe quick-connect structure according to claim 1, wherein the connecting piece further comprises:
a second plug-in portion, arranged at a second end of the first plug-in portion and having an outer diameter smaller than that of the first plug-in portion, wherein a first sealing ring is radially assembled on an outer side wall of the second plug-in portion, the first sealing ring abutting against and sealing an inner wall of the third accommodating cavity;
an annular edge portion, arranged between the first plug-in portion and a first oil needle portion to limit the first oil pipe, wherein the first oil needle portion is arranged on the first end of the connecting piece, and an oil pipe sleeve for externally compressing and fixing the first oil needle portion and the first oil pipe is assembled on the free end of the first oil pipe;
an extension portion, integrally formed at one end of the second plug-in portion facing away from the first plug-in portion.

4. The oil pipe quick-connect structure according to claim 3, wherein the snap portion comprises:
main snap portions, at least one in number and arranged on an annular side wall of the first plug-in portion near the second plug-in portion;
auxiliary snap portions, at least one in number, arranged on the annular side wall of the first plug-in portion near the second plug-in portion and circumferentially staggered relative to the first plug-in portion, having a same width as the main snap portions, and having a length greater than that of the main snap portions and smaller than a height of the second accommodating cavity;
the bayonet portion comprises:
main bayonet portions, opened on the side wall surface of the first accommodating cavity and communicating with the second accommodating cavity, the number of which matches the number of the main snap portions;
auxiliary bayonet portions, opened on the side wall surface of the first accommodating cavity and communicating with the second accommodating cavity, the number of which matches the number of the auxiliary snap portions.

5. The oil pipe quick-connect structure according to claim 3, wherein the elastic piece comprises:
a fourth accommodating cavity, provided in an inner cavity of the main body portion near its second end and communicating with the third accommodating cavity, wherein an inner diameter of the fourth accommodating cavity is smaller than the inner diameter of the third accommodating cavity;
a positioning block, movably assembled within the fourth accommodating cavity, having a first end abutting the extension portion, and a diameter larger than the inner diameter of the third accommodating cavity, and having a second end formed with a spring sleeve portion;
a positioning spring, sleeved on the spring sleeve portion to elastically position the positioning block at a step where the fourth accommodating cavity meets the third accommodating cavity.

6. The oil pipe quick-connect structure according to claim 5, wherein the main body portion comprises:
a first adapter body, axially provided with the first accommodating cavity, the second accommodating cavity, and the third accommodating cavity, and having an external threaded portion at its second end;
a second adapter body, axially provided with the fourth accommodating cavity, and having an internal threaded portion in its inner cavity near one end of the first adapter body, wherein the internal threaded portion is threadedly connected to the external threaded portion to connect the first adapter body and the second adapter body to form the main body portion.

7. The oil pipe quick-connect structure according to claim 6, wherein the main body portion comprises:
a third sealing ring provided between the first adapter body and the second adapter body.

8. The oil pipe quick-connect structure according to claim 1, wherein the adapter piece is assembled on a connection end of an upper brake pump and a lower brake pump via a union mechanism and communicates with the oil paths of the upper brake pump and the lower brake pump, the union mechanism comprising:
an adapter step, integrally formed on an annular side wall of the main body portion near its second end;
a union sleeve, movably sleeved on the annular side wall of the main body portion, and abutting against the adapter step for axial limitation after being assembled with the first end of the main body portion, having an outer annular wall provided with external threads matching preset internal threads within the connection end;
wherein, an end of the union sleeve near the connecting piece is formed with a hexagonal screw head portion for cooperating with a wrench tool.

9. The oil pipe quick-connect structure according to claim 8, wherein a second sealing ring is radially assembled on an outer side wall of the main body portion near its second end, the second sealing ring abutting against and sealing an inner wall surface of the connection end.

10. The oil pipe quick-connect structure according to claim 1, wherein a second oil needle portion is integrally formed at a second end of the adapter piece, and the second oil needle portion is inserted and fixed inside a second oil pipe which is hollow, to connect the oil path of the first oil pipe and the second oil pipe after a snap-and-twist quick-connection.

11. A hydraulic disc brake system, wherein the hydraulic disc brake system comprises the oil pipe quick-connect structure according to claim 1.
